(19) United States
(12) Patent Application Publication
(10) Pub. No.: US 2023/0394026 A1
(43) Pub. Date: Dec. 7, 2023

(54) TECHNIQUES FOR LEARNING THE BEST ORDER OF IDENTIFIERS SYSTEM IN AN ONLINE MANNER

(71) Applicant: INTERNATIONAL BUSINESS MACHINES CORPORATION, ARMONK, NY (US)

(72) Inventors: Manish Kesarwani, Bangalore (IN); Akshar Kaul, Bangalore (IN); Hong Min, Hopewell Junction, NY (US)

(21) Appl. No.: 17/805,547

(22) Filed: Jun. 6, 2022

(51) Int. Cl. G06F 16/23

(52) U.S. Cl. CPC G06F 16/23

(57) ABSTRACT

A method, computer system, and a computer program product for processing a computer dump by receiving at least one page of the computer system dump. The page includes a plurality of data tokens. The page may be parsed to extract a plurality of data tokens. The order of identifiers may be then determined for processing by using a probability sampling model. The probability sampling model calculates a plurality of reward based weights for each identifier using the tokens. The page may then be processed using the determined order of identifiers. The reward based weights may be updated after pages has been processed by determining frequency of each identifier detected during page processing.

### BACKGROUND

The present invention relates generally to the field of digital diagnostic computing, and more particularly to techniques for learning the best order of identifiers in an online manner.

Diagnostics dumps may be generally captured during system failure in a computing environment. To enable correct diagnosis and successful resolution of the issued later, diagnostic dumps collect information about the entire system. A variety of data may be collected during these dumps either routinely and before a problem arises or after the occurrence of the problem. This may include intricacies about trace and debugging utilities, run time data, commands and any other information that can help identify, isolate and solve run time problems. Different types of diagnostic data may be automatically produced by default when certain events occur, but others can be captured and even triggered from the command line.

One challenge with collecting dumps may be that they contain all sorts of information including sensitive data. This can cause concerns that sensitive information is shared with unauthorized entities when dumps have to be shared with third party entities. These third party entities may be vendors, customers or others that do not usually have access to sensitive and proprietary information captured by the dump.

Exposure of sensitive data may affect organizations or even individuals both financially and legally. Prior art requires individual analysis and detection of sensitive data and removal of it from the system dump using techniques that may be very time consuming and inefficient. In addition, these techniques cause major bottlenecks in the utility of these services. Therefore, improvements need to be made in these circumstances that resolve the current prior art issues.

### SUMMARY

Embodiments of the present invention disclose a method, computer system, and a computer program product for processing a computer dump by receiving at least one page of the computer system dump. The page includes a plurality of data tokens. The page may be parsed to extract a plurality of data tokens. The order of identifiers may be then determined for processing by using a probability sampling model. The probability sampling model calculates rank using a plurality of reward based weights for each identifier using the tokens. The page may then be processed using the determined order of identifiers. The reward based weights may be updated after the page has been processed by determining frequency of each identifier detected during page processing.

### BRIEF DESCRIPTION OF THE SEVERAL VIEWS OF THE DRAWINGS

These and other objects, features and advantages of the present invention will become apparent from the following detailed description of illustrative embodiments thereof, which may be to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 provides an operational flowchart illustrating dynamic processing of a computer dump according to at least one embodiment;

FIG. 3 provides an illustration of an example having a plurality of identifiers according to at least one embodiment;

FIG. 4 provides an exemplary illustration showing frequency of each identifier appearing on a page as per embodiment of FIG. 3;

FIG. 5 provides an illustration of calculating a reward system based on a plurality of identifiers and frequencies according to at least one embodiment;

FIG. 6a provides a block diagram showing the best “Identifier Order Detection” technique in accordance with an embodiment of the present disclosure;

FIG. 6b provides a block diagram of a data privacy for diagnostic (DPFD) system in accordance with an embodiment of the present disclosure;

FIG. 7 provides a block diagram of internal and external components of computers and servers depicted in FIG. 1 according to at least one embodiment;

FIG. 8 provides a block diagram of an illustrative cloud computing environment including the computer system depicted in FIG. 1, in accordance with one embodiment; and

FIG. 9 provides a block diagram of functional layers of the illustrative cloud computing environment of FIG. 8, in accordance with an embodiment.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but may not be limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to customize the electronic circuitry, in order to perform aspects of the present invention.

Aspects of the present invention may be described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for dynamically processing a computer dump. In one embodiment, this comprises receiving at least one page of the computer system dump. The page includes a plurality of data tokens. The page may be parsed to extract a plurality of data tokens. The order of identifiers may be then determined for processing by using a probability sampling model. The probability sampling model calculates rank using a plurality of reward based weights for each identifier using the tokens. The page may then be processed using the determined order of identifiers. The reward based weights may be updated after the page has been processed by determining frequency of each identifier detected during page processing.

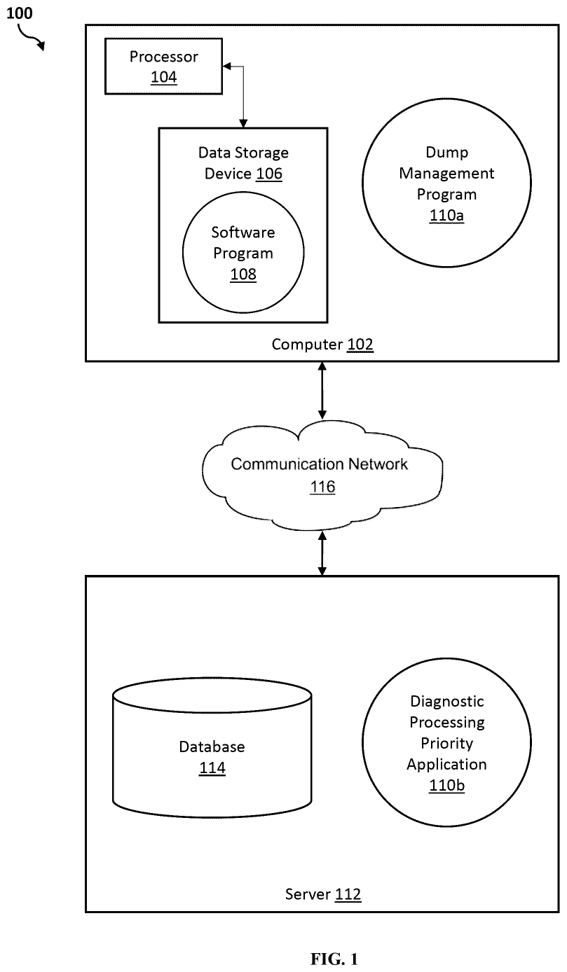

FIG. 1 provides an exemplary networked computer environment 100 in accordance with one embodiment. The networked computer environment 100 may include a computer 102 with a processor 104 and a data storage device 106, enabled to run a software program 108 and a dump management program 110a. The networked computer environment 100 may also include a server 112, enabled to run diagnostic processing priority application 110b that may interact with a database 114 and a communication network 116. The networked computer environment 100 may include a plurality of computers 102 and servers 112, only one of which has been shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

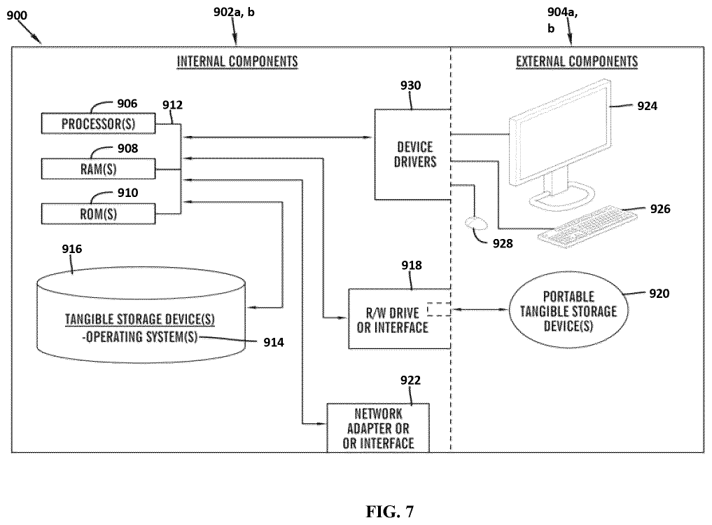

The client computer 102 may communicate with the server computer 112 via the communications network 116. The communications network 116 may include connections, such as wire, wireless communication links, or fiber optic cables. As will be discussed with reference to FIG. 7, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as an exclusive cloud, community cloud, public cloud, or hybrid cloud. Client computer 102 may be, for example, a mobile device, a telephone, a customized digital assistant, a netbook, a laptop computer, a tablet computer, a desktop computer, or any type of computing devices capable of running a program, accessing a network, and accessing a database 114. According to various implementations of the present embodiment, dump management program 110a, and a diagnostic processing priority application 110b may interact with a database 114 that may be embedded in various storage devices, such as, but not limited to a computer/mobile device 102, a networked server 112, or a cloud storage service.

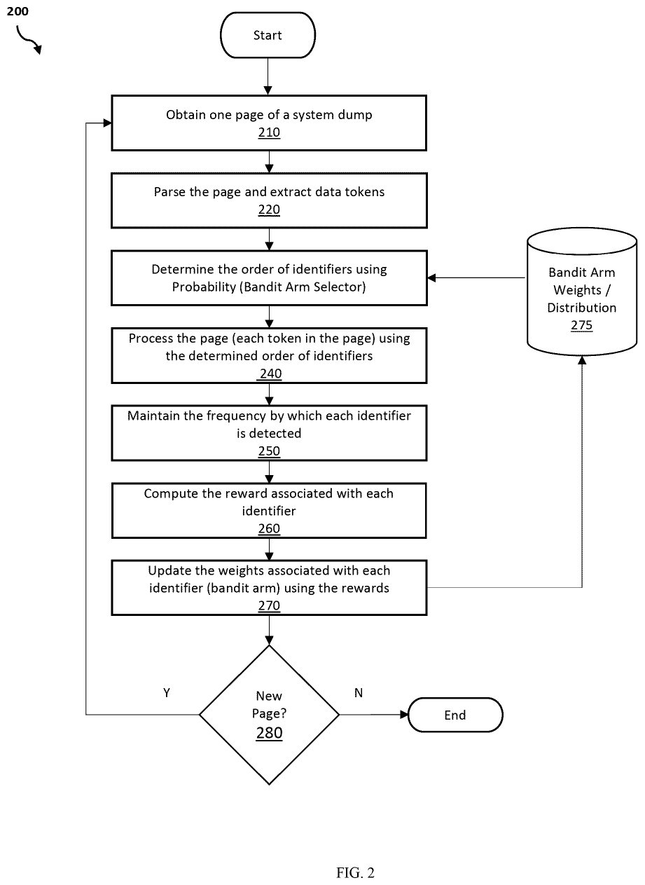

According to the present embodiment, a user using a client computer 102 or a server computer 112 may use the program/application 110a, 110b (respectively) to provide a dump and diagnostic management technique. This technique will be provided in more detail below with respect to FIGS. 2 through 6.

Referring now to FIG. 2, a flowchart depiction for techniques to provide dynamic management of a system dumps is provided as provided as per one embodiment. This technique 200 as discussed will cut down on the time associated with analysis of data dumps and gains significant time improvement over prior art currently being utilized.

In Step 210, at least one page of a computer system dump is provided. This page has a plurality of data tokens. In one embodiment, the dump may be dynamically collected/taken and subsequent pages may be presented on a one by one basis for processing as they are being collected. Subsequent pages may be presented as a first page (or previous pages) may be processed. This has the advantages of the information, such as the frequency of identifiers, to evolve during the processing of large dump files. In this scenario, to provide an ease of understanding, the illustration flowchart provides a first page of the dump being obtained.

In Step 220, this first page may be parsed to obtain one or more data tokens associated with the page. This may be different than prior art systems that use a set of identifiers and considers them in a fixed order throughout the analysis of the dump. In this embodiment, the order of the identifiers significantly affects the performance of this system since each identifier may be tested sequentially until a match may be found the system administrator does not have access to the frequency information at the beginning of the execution.

In Step 230, an order of identifiers for processing may be determined based on the number of identifiers. In one embodiment, the order of identifiers may be determined based on a calculated weight associated with each identifier. The latter may be calculated by using a probability distribution function such as the bandit arm selector function.

In steps 240, the tokens and ultimately the page may be processed using the selected order of identifiers. The order of selection and processing as can be seen at 275 may be determined by a probability distribution selector such as a bandit arm distribution calculator that associates weights to each identifier. In one embodiment, the calculation may involve the incorporation of an exploitation and an exploration factor.

In Step 250, during the processing of the tokens and the page, the frequency of each identifier may be maintained. This will enable an association of predicted order of identification with an actual sense of the frequency of each identifier as the page will be processed.

In Step 260, once the tokens and the first page has been processed, based on the frequency of each identifier determined and the previous order, a reward may be calculated for each identifier.

In Step 270, based on the frequency of detection of each identifier, a reward is generated and associated with each identifier after the completion of the first parsed page. This reward will then be converted to a weight as part of the calculation of the identifiers which will reiteratively and dynamically be considered in providing new orders of identifier ordering.

The weights previously calculated in Steps 230/240 and by the weight distribution calculator 275 will be updated based on the new rewards generated and associated with the identifiers. The updated weight associated with each identifiers using the rewards are then provided for the Bandit arm calculator 275 for the following page processing.

After this selection other pages can be obtained/received as the dump may be being taken and processed in a similar fashion The identifiers selected, may be different for every page. In addition, once the page has been processed, the actual rewards associated with predicting and selecting the identifiers may be used in subsequent pages as was discussed earlier. This process can end when no more pages are provided for processing, or alternatively iteratively repeated until the dump collection has been completed and/or processed entirely as shown at decision block 280.

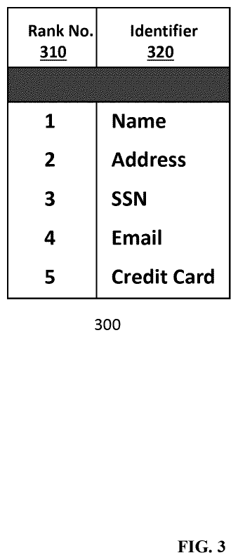

Now looking at FIG. 3, as previously mentioned, diagnostic dumps may be generally captured during system failure. Dump files often contain entire memory snapshot at the time of failure which possibly contains sensitive data. Having accurate diagnostic data available has many advantages when it comes to preventing future problems and fixing current conditions that caused the failure. However, there may be some distinct disadvantages. For one, system dumps may be very large and require large amount of storage. Another issue has to do with the fact that system dumps may have to be shared with third party entities, such as customers and vendors, for diagnostics reasons. This may pose a critical risk to exposure of any sensitive data. Exposure of sensitive data may affect the organization both financially and legally. Hence there may often be a need to analyze diagnostics dumps at source before sending it to third parties (customers, vendors etc.). Traditional methods for analyzing and detecting sensitive data in a system dump, require a long period of analysis that may become as long as several days. The latter causes major bottlenecks in the utility of many of the services provided by the system. FIGS. 3-6 provide techniques that addresses some of the current issues.

Referring back to FIG. 3, an exemplary illustration may be provided to help understand some of the concepts that will be presently discussed. The table provided in FIG. 3 may be an example of a table generated during an imaginary dump. This table can now be used to first review prior art practices and then used in scenarios using the present invention to help discuss different embodiments.

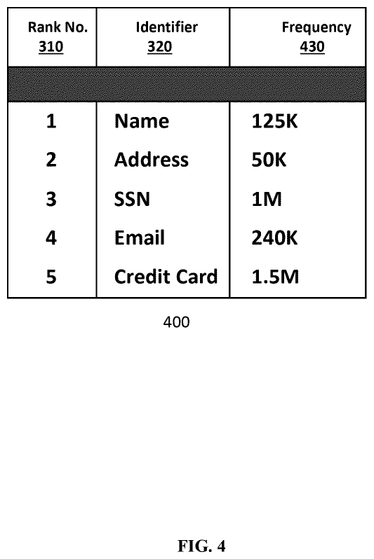

In FIG. 3, a set of identifiers may be provided in the table enumerated by 300. In many prior art systems, these identifiers will be utilized in a fixed order and so the order of the identifiers significantly affects the performance of the overall system. This may be because each identifier may be tested sequentially until a match has been found. For example, looking at FIG. 4, the corresponding table 300 shows the order 310 in which the identifiers 320 may be tested as well as the frequency 430 of each identifier in the dump file. In some instances, the system administrator does not have access to the frequency information at the beginning of the execution. Furthermore, the frequency of identifiers will evolve during the processing of large dump files. In one scenario, throughout an analysis process conducted in FIG. 3, every credit card number token may be first compared to all other identifiers. This may be very inefficient and wastes many processing cycles, such as central processing unit cycles (CPU cycles). As discussed earlier, this leads to bottlenecks that prevent the use of some utilities.

In FIGS. 4-6, a dynamic execution order may be selected for the set of chosen identifiers. The DPFD system will be efficiently executing the dump by determining an optimal order of identifiers. In one embodiment, for each data page a different order of execution could be selected. In this embodiment, these may automatically converge to a best order of identifiers without any human input. In one embodiment, this may be achieved by learning an estimate of improvement by exploring different execution orders at different times during the execution. The objective may then be to learn and determine the best order of execution of the identifiers during the processing of the dump through DPFD, more specifically in an online manner.

Machine learning and probability theories may be used to provide a solution where a fixed set of resources may be allocated between competing and alternate choices in a manner to maximize efficiency and provide optimal gain. This approach may be even more beneficial where each choice properties may only be partially known at the time of resource allocation and may become better understood as time passes or by allocating resources to the choice.

A well-known concept in probability theory that exemplifies the exploration—exploitation tradeoff dilemma has been referenced as one or multi “arm bandit” theory. The name comes from imagining a person gambling at a row of slot machines. The gambler has to decide which machines to play, how many times to play each machine and in which order to play them, and whether to continue with the current machine or try a different machine. In these problems, each machine provides a random reward from a probability distribution specific to that machine (and not known previously). The objective of the gambler may be to maximize the sum of rewards earned through a sequence of lever pulls. The crucial tradeoff the gambler faces at each trial may be between “exploitation” of the machine that has the highest expected payoff and “exploration” to get more information about the expected payoffs of the other machines. The trade-off between exploration and exploitation may also be crucial in machine learning.

In a situation where k slot machines may be used to play, the gambler must function as a multi-armed bandit. In this problem, the gambler must choose which of the K slot machines to play. As discussed, at each time step, the gambler pulls the arm of one of the machines and receives a reward or payoff. The reward distribution may be assumed to be fixed over time. The gambler's purpose may be to maximize his return. The sum of the rewards he receives over a sequence of pulls. In this model, each arm may be assumed to deliver rewards that may be independently drawn from a fixed and unknown distribution. As reward distributions differ from arm to arm, the goal may be to find the arm with the highest expected payoff as early as possible, and then to keep gambling using that best arm (a paradigmatic trade-off example between exploration and exploitation).

Looking in the example of FIG. 3, in this scenario an “Adversarial Bandit” problem may be created, since the location of sensitive data in different dump pages may not follow any known distribution. The adversarial bandit problem may be a variant of the bandit problem discussed above and considers a scenario where no statistical assumptions may be made about the generation of rewards. In this example, the location of sensitive data in different dump pages may not follow any known distribution. In the scenario of FIG. 3, the identifier set consists of 5 different identifiers as shown in table column 320. These may be “Name, Address, SSN, Email and Credit Card” in this scenario. Using each distinct identifier as a bandit arm, this creates k=5 bandit arms in this scenario.

In one embodiment, it may be assumed that at the beginning all the orderings may be equally best, so initially all the arms may be equally likely to be selected as best arm. Now the analysis can be provided using one embodiment in which the adversarial bandit problem may be considered to select the ordering of identifiers before processing a new data page. In this scenario, all the bandit arms may be sampled from their respective distributions. The sampling of arms provides an ordering of the identifiers. In one embodiment, the DFPD processes may be used to process one or more pages using the selected order of identifiers. After a data page has been processed, the rewards may be computed.

In FIG. 4, the table 400, includes the frequency 430 of each identifier appearing on the page may be obtained. This may be different for each page. In the exemplary scenario discussed, the earlier the token may be detected, the more efficient the system becomes. In one example, the reward points to the identifiers may be assigned in descending order. For example, if the selected order may be [Name, SSN, Address, Email, Credit Card], the identifiers may be ranked in a decreasing order:
Name—5, SSN—4, Address—3, Email—2 and Credit Card—1
   In this case, when a page will be processed, the system will keep a count of each detected identifier. For example, in the current page, following may be the frequency of each identifier:
Name—20, SSM—40, Address—10, Email—5, Credit Card—2

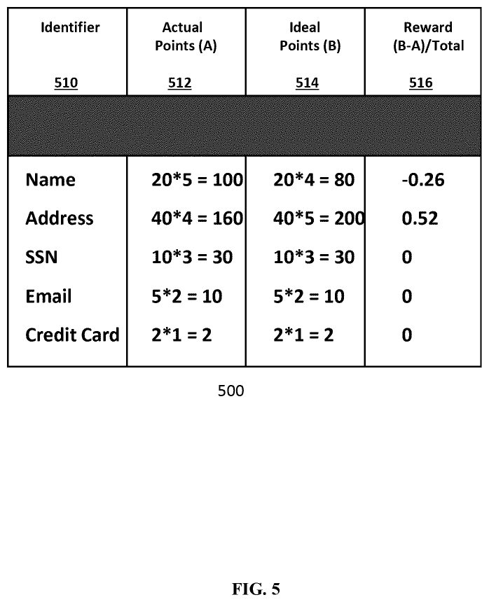

In FIG. 5, the table 500 provides a graphical illustration of one embodiment where reward computation has been initiated. Using the rewards generated in FIG. 5, the selection probability of all the arms may be updated. The process may be repeated iteratively as appropriate as explored in FIG. 2 at 260.

In this case, adding the numbers that appear under the Actual Points 512, provide a total hit equal to 77. (Total Hits: 20+40+10+5+2=77). The Rewards then may be computed as shown in the table of FIG. 5 for this example. In 512, actual points will be a multiple of the hits as a function of each identifier (510) rank. The ideal points may then be calculated in 514 based on an optimal rank as a function of the hits and a reward 516 calculated. In this scenario, there may only a deviation only for Name and SSN as shown.

This example can now be expressed in a more methodical manner as per one embodiment. In this embodiment, an exploration parameter may be selected as γ in (0,1]. Since initially all the orderings may be equally likely, so let the weight of each arm be equal to 1. For k possibilities, this can be expressed mathematically as:

wᵢ(1)=1for i=1,K

For each page t=1, 2, . . . ,

$${p}_{i} ( t ) = ( 1 - Y ) \frac{{w}_{i} ( t )}{{\sum }_{j = 1}^{K} {w}_{j} ( t )} + \frac{γ}{K} for i = 1 , … , K$$

The Exploitation part can be identified as

$$\frac{{w}_{i} ( t )}{{\sum }_{j = 1}^{K} {w}_{j} ( t )}$$

and the exploration part as

$$\frac{γ}{K} . K$$

Now a sample from each arm can be drawn having a probability of p₁(t), . . . , p_{K}(t). The order of identifiers can be selected based on samples. The DPFD can now run on this page using the selected order of identifiers and the reward recoded. The weights can now be updated for j=1, . . . K, set as:

x′ⱼ(t)=xⱼ(t)/pⱼ(t)

wⱼ(t+1)=wⱼ(t)exp((γ*x′ⱼ(t))/K)

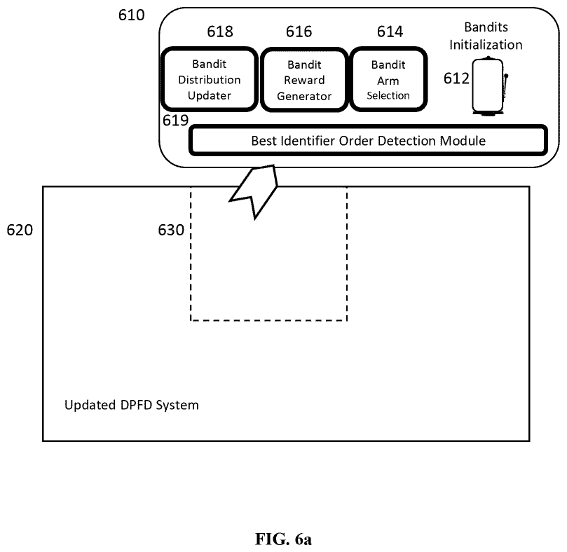

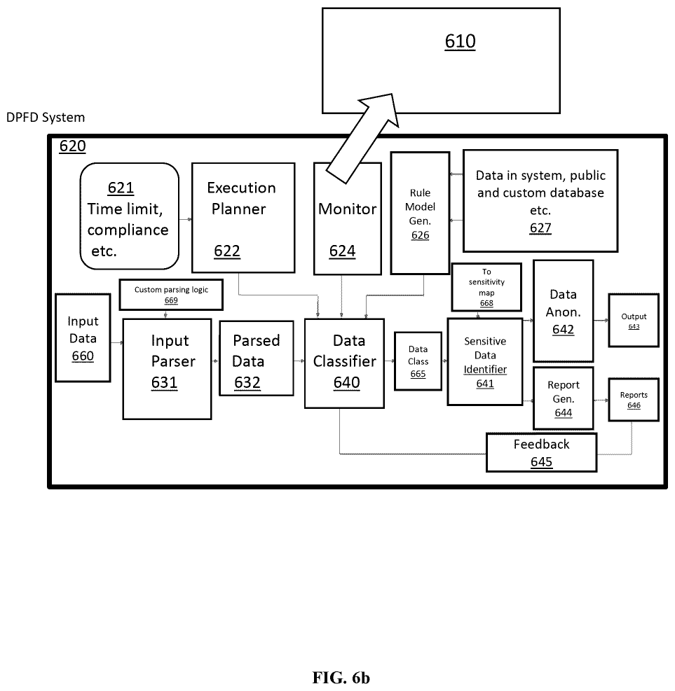

This can be understood operationally in conjunction with the block diagrams of FIGS. 6a and 6b. FIGS. 6a and 6b show the system architecture connected with the premise provided above.

FIG. 6a provides a DPFD 620 and selection component 610 that may be interrelated. The DPFD system in FIG. 6a provides to the selection component 610, the best identifiers of order detection (619). The selectors (bandits) may be initialized 612. This will lead to the bandit arm selection 614 (based on identifier order 619) and a correlating reward generator 616. Once each selection has been made, there may be an update to select the next candidate as provided by 618. Once there has been an update this (reinitialization, end of process etc.), this will get inputted back to the DPFD which will be updated (and the process may be reiterated).

The inner workings of the DPFD System 620 may be provided as per one embodiment by the block diagram illustration of FIG. 6b. As shown the process starts by receiving input 621 that will be provided to the data planner data Execution Planner 622. This input can be a variety of different input types. User input can be provided but also other types of information may be provided including time limits, system workload, target applications and any rules such as compliance requirements and rules. The Execution Planner 622 may process both static and dynamic information. This can include data specific and metadata specific information as well as regulation (specifics) and semantic checking information.

The output of the Execution Planner 622 may then be provided alongside the outputs of the Monitor 624 and Rule and Model Generator 626 to a Data Classifier 640. The Monitor 624 provides runtime behavior data to the Data Classifier 640. The Monitor 624 both provides information and obtain information form the Selection component 610 (see FIG. 6a) to provide order of detection information for sensitive information and provide additional information from the Order of Detection Module 619 to act upon as appropriate. The Rule and Model Generator 626 receives input from different Knowledge Databases 627 that may be public or customized. It also gathers data in other system files and databases as appropriate.

Besides receiving data input from the Execution Planner 624, Monitor 624 and Rule and Model Generator 626, the Data Classifier 640 also gets input from an Input Parser 631. The Input Parser 631 can receive input data and other custom parsing logic 669 (address space logic, character set logic, custom logic etc.) to provide a parsed set of data (632) to the Data Classifier 640. The parsed data can include free text or transformed and contextually enriched data.

The Data Classifier 640 groups classes of data 665 that may be rule based or learning based and may even be used—for example—for machine learning or artificial intelligence purposes. These data classes may then be processed for finding the sensitive data by Sensitive Data Identifier 641. This data may include data that needs to be protected as proprietary or sensitive based. Class of data that needs to be treated can be mapped previously. Once the data has been flagged as sensitive, the data may be replaced, hashed, encrypted or otherwise anonymized as could be understood by one skilled in the art. In one embodiment, the Data Anonymizer 642 then provides an output file 643 that may be devoid of all sensitive data. This data has been removed or manipulated so the file may be provided to third parties. In one embodiment, a Report Generator 644 may also be included that provide information about the reports 646 and the flagging of the sensitive information and its anonymizing. This process can be reiterated, and information provided back to the Sensitive Data Identifier 641 through the feedback loop 645 as indicated.

FIG. 7 provides a block diagram 900 of internal and external components of computers depicted in FIG. 1 in accordance with an illustrative embodiment of the present invention. It should be appreciated that FIG. 7 provides only an illustration of one implementation and does not imply any limitations with regard to the environments in which different embodiments may be implemented. Many modifications to the depicted environments may be made based on design and implementation requirements.

Data processing system 902, 904 may be representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but may not be limited to, individual computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 7. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the dump management program 110a in client computer 102, and the diagnostics processing priority application 110b in network server 112, may be stored on one or more computer-readable tangible storage devices 916 for execution by one or more processors 906 via one or more RAMs 908 (which typically include cache memory). In the embodiment illustrated in FIG. 7, each of the computer-readable tangible storage devices 916 may be a magnetic disk storage device of an internal hard drive. Alternatively, each of the computer-readable tangible storage devices 916 may be a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108, the dump management program 110a and the diagnostic processing priority application 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the dump management program 110a in client computer 102 and the diagnostic processing priority application 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the dump management program 110a in client computer 102 and the diagnostic processing priority application 110b in network server computer 112 may be loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It should be understood in advance that although this disclosure includes a detailed description on cloud computing, implementation of the teachings recited herein may not be limited to a cloud computing environment. Rather, embodiments of the present invention may be capable of being implemented in conjunction with any other type of computing environment now known or later developed.

Cloud computing provides a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics may be as follows:

On-demand self-service: a cloud consumer can unilaterally provision computing capabilities, such as server time and network storage, as needed automatically without requiring human interaction with the service's provider.

Broad network access: capabilities may be available over a network and accessed through standard mechanisms that promote use by heterogeneous thin or thick client platforms (e.g., mobile phones, laptops, and PDAs).

Resource pooling: the provider's computing resources may be pooled to serve multiple consumers using a multi-tenant model, with different physical and virtual resources dynamically assigned and reassigned according to demand. There may be a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models may be as follows:

Software as a Service (SaaS): the capability provided to the consumer may be able to use the provider's applications running on a cloud infrastructure. The applications may be accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer may be deployed onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer may be to provision processing, storage, networks, and other fundamental computing resources where the consumer may be able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models may be as follows:

Customized and Individual cloud: the cloud infrastructure may be operated solely for an organization. It may be managed by the organization or a third party and may exist on-premises or off-premises.

Community cloud: the cloud infrastructure may be shared by several organizations and supports a specific community that has shared concerns (e.g., mission, security requirements, policy, and compliance considerations). It may be managed by the organizations or a third party and may exist on-premises or off-premises.

Public cloud: the cloud infrastructure may be made available to the general public or a large industry group and may be owned by an organization selling cloud services.

Hybrid cloud: the cloud infrastructure may be a composition of two or more clouds (customized and individual, community, or public) that remain unique entities but may be bound together by standardized or proprietary technology that enables data and application portability (e.g., cloud bursting for load-balancing between clouds).

A cloud computing environment may be a service oriented with a focus on statelessness, low coupling, modularity, and semantic interoperability. At the heart of cloud computing may be an infrastructure comprising a network of interconnected nodes.

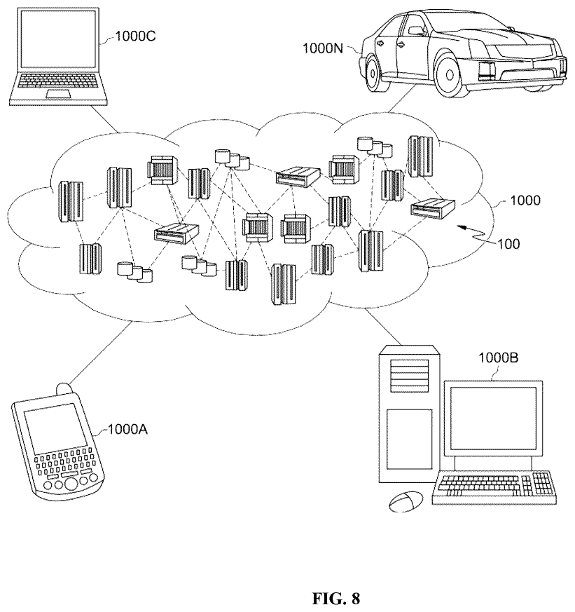

Referring now to FIG. 8, illustrative cloud computing environment 1000 may be depicted. As shown, cloud computing environment 1000 comprises one or more cloud computing nodes 100 with which local computing devices used by cloud consumers, such as, for example, digital assistants (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as exclusive, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It may be understood that the types of computing devices 1000A-N shown in FIG. 8 may be intended to be illustrative only and that computing nodes 100 and cloud computing environment 1000 can communicate with any type of computerized device over any type of network and/or network addressable connection (e.g., using a web browser).

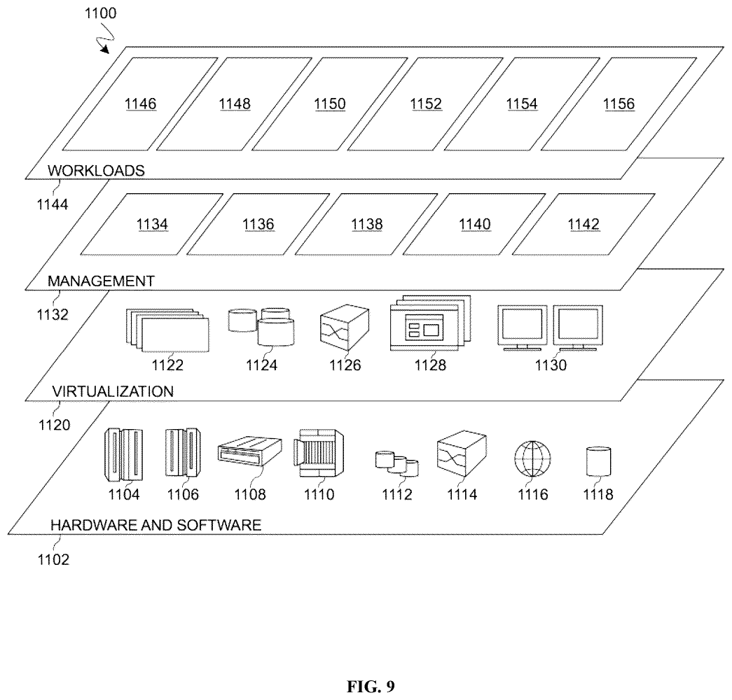

Referring now to FIG. 9, a set of functional abstraction layers 1100 provided by cloud computing environment 1000 has been shown. It should be understood in advance that the components, layers, and functions shown in FIG. 8 may be intended to be illustrative only and embodiments of the invention may be not limited thereto. As depicted, the following layers and corresponding functions may be provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual exclusive networks; virtual applications and operating systems 1128; and virtual clients 1130.

In one example, management layer 1132 may provide the functions described below. Resource provisioning 1134 provides dynamic procurement of computing resources and other resources that may be utilized to perform tasks within the cloud computing environment. Metering and Pricing 1136 provide cost tracking as resources may be utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels may be met. Service Level Agreement (SLA) planning and fulfillment 1142 provide pre-arrangement for, and procurement of, cloud computing resources for which a future requirement may be anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and data management 1156.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for dynamically processing a computer dump, comprising:
receiving at least one page of a computer system dump, wherein said page includes a plurality of data tokens;
parsing said page to extract a plurality of data tokens;
determining an order of identifiers for processing said page by using a probability sampling model; wherein said probability sampling model calculates a plurality of reward based weights for each identifier using said tokens;
processing said page using said determined order of identifier;
updating said reward based weights after said page is processed by determining frequency of each identifier detected during page processing.

2. The method of claim 1, wherein said probability distribution function is a multi-bandit probability distribution.

3. The method of claim 2, wherein every identifier is considered as an arm of said bandit for said probability distribution.

4. The method of claim 3, wherein an exploration and exploitation factors are calculated for said rewards.

5. The method of claim 4, wherein said exploration and exploitation factors are calculated using the multi-bandit probability distribution for determining said reward based weights.

6. The method of claim 3, wherein every identifier is considered as an equally likely arm of a bandit to be selected.

7. The method of claim 3, further comprising:
receiving a new second page for processing having a plurality of data tokens;
parsing said second page to extract a plurality of new data tokens;
determining a new order of identifiers for processing by using said probability sampling model; wherein said probability sampling model calculates rank using a plurality of new reward based weights for each identifier by also using said updated weights from said first page;
processing said second page using said new determined order of identifiers;
updating said reward based weights after said second page is processed by determining frequency of each identifier detected during second page processing.

8. The method of claim 7, wherein said page and said second page share at least some of said set of identifiers.

9. The method of claim 7, wherein additional pages are received one after another until the dump is completed after said second page is completed; and said same process as in method of claim 7 is repeated for each page.

10. A computer system for detecting a session status based on a cookie associated with the session, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving at least one page of a computer system dump, wherein said page includes a plurality of data tokens;
parsing said page to extract a plurality of data tokens;
determining an order of identifiers for processing said page by using a probability sampling model; wherein said probability sampling model calculates a plurality of reward based weights for each identifier using said tokens;
processing said page using said determined order of identifier;
updating said reward based weights after said page is processed by determining frequency of each identifier detected during page processing.

11. The computer system of claim 10, wherein said probability distribution function is multi-bandit probability distribution.

12. The computer system of claim 11, wherein every identifier is considered as an arm of said bandit for said probability distribution.

13. The computer system of claim 12, wherein an exploration and exploitation factors are calculated using the multi-bandit probability distribution for determining said reward based weights.

14. The computer system of claim 12, wherein every identifier is considered as an equally likely arm of a bandit to be selected.

15. The computer system of claim 10, further comprising:
receiving a new second page for processing having a plurality of data tokens;
parsing said second page to extract a plurality of new data tokens;
determining a new order of identifiers for processing by using said probability sampling model; wherein said probability sampling model calculates rank using a plurality of new reward based weights for each identifier by also using said updated weights from said first page;
processing said second page using said new determined order of identifiers;
updating said reward based weights after said second page is processed by determining frequency of each identifier detected during second page processing.

16. A computer program product for detecting a session status based on a cookie associated with the session, comprising:
one or more computer-readable storage medium and program instructions stored on at least one of the one or more tangible storage medium, the program instructions executable by a processor, the program instructions comprising:
receiving at least one page of a computer system dump, wherein said page includes a plurality of data tokens;
parsing said page to extract a plurality of data tokens;
determining an order of identifiers for processing said page by using a probability sampling model; wherein said probability sampling model calculates a plurality of reward based weights for each identifier using said tokens;
processing said page using said determined order of identifier;
updating said reward based weights after said page is processed by determining frequency of each identifier detected during page processing.

17. The computer program product of claim 16, wherein said probability distribution function is multi-bandit probability distribution.

18. The computer program product of claim 17, wherein every identifier is considered as an arm of said bandit for said probability distribution.

19. The computer program product of claim 18, wherein an exploration and exploitation factors are calculated using the multi-bandit probability distribution for determining said reward based weights.

20. The computer program product of claim 19, wherein every identifier is considered as an equally likely arm of a bandit to be selected.
